(19) United States
(12) Patent Application Publication
(10) Pub. No.: US 2010/0290864 A1
(43) Pub. Date: Nov. 18, 2010

(54) PLATE MEMBER FASTENER

(75) Inventor: KUO-CHUNG WANG, SILUO TOWNSHIP (TW)

Correspondence Address: KUO-CHUNG WANG, P.O. BOX 108-00403, TAIPEI, 106, omitted

(73) Assignee: KUO-CHUNG WANG, SILUO TOWNSHIP (TW)

(21) Appl. No.: 12/464,884

(22) Filed: May 13, 2009

(51) Int. Cl. F16B 35/02

(52) U.S. Cl. 411/383

(57) ABSTRACT

A plate member fastener includes a barrel bonded to a mounting through hole of a first metal plate member through a reflow bonding process, a screw member, which is inserted through the barrel after bonding of the barrel to the first metal plate member and threaded into a screw hole of a second metal plate member to joint the first and second metal plate members together, a cap molded on the head of the screw member and axially movably coupled to the barrel for gripping by a user to rotate the screw member into or out of the screw hole of the second metal plate member, and a spring member sleeved onto the shank of the screw member and stopped between the head of the screw member and a step inside the barrel to force the cap outwards relative to the barrel.

### BACKGROUND OF THE INVENTION

1. Field of the Invention

The present invention relates to a plate member fastener for joining two metal plate members and more particularly, to such the plate member fastener for joining a first metal plate member and a second metal plate member together, which allows bonding of the barrel thereof to the first metal plate member before installation of a screw member with an attached spring member and a cap to the barrel, preventing color fading or softening of the cap or high temperature tempering of the spring member during reflow bonding to bond the barrel to the first metal plate member.

2. Description of the Related Art

When fastening plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together.

The power drive or speed-adjustment unit of a machine tool is provided inside the housing. To facilitate repair of the machine tool or adjustment of the output speed of the machine tool, a detachable plate member is usually provided at the housing of the power drive or speed-adjustment unit. Screw bolts are commonly used to fasten the movable plate member to the housing. When unfastening screw bolts to dismount the movable plate member from the housing, the associating lock nuts may fall from the screw bolts.

There is known a plate member fastener comprised of a cap, a screw, a spring member and a locating base for joining two metal plate members together. After fixation of the locating base of the plate member fastener to a through hole on a first plate member, the screw is threaded into a screw hole on a second plate member to secure the first plate member and the second plate member together. Because the locating base of the plate member fastener is kept secured to the first plate member after removal of the first plate member from the second plate member, the plate member fastener will not be missed by accident. According to this design, the cap is a metal member. After the screw is accommodated in the cap, a machine tool is used to process the cap so that retaining protrusions are formed on the cap and forced into engagement with the screw. This processing process requires high precision and wastes time and labor. During processing, the cap may be compressed excessively, resulting in permanent deformation. To eliminate this problem, the cap can be formed of a plastic material and directly molded on the screw. Directly molding the cap on the screw does not require any secondary processing process and saves much the cost. Further, through a molding technique, the cap can be made in any of a variety of shapes and colors and having damp-proof and anticorrosive characteristics. Further, during installation of the plate member fastener, an automatic installation machine is used to pick up the cap and then to insert the locating base into the mounting through hole of the first plate member. Thereafter, the locating base is bonded to the first plate member with a solder paste by means of a reflow soldering process. When bonding the locating base to the first plate member through a reflow soldering process, heat produced during the reflow soldering process may cause the plastic to fade or to be softened or burned out, and the spring member may be tempered by the high temperature to weaken its structural strength.

Therefore, it is desirable to provide a plate member fastener that eliminates the aforesaid problems.

### SUMMARY OF THE INVENTION

The present invention has been accomplished under the circumstances in view. It is therefore an object of the present invention to provide a plate member fastener for joining metal plate members, which keeps the plastic cap, the screw member and the spring member away from heat during a reflow soldering process to bond the barrel of the plate member fastener, avoiding fading or softening of the plastic cap or high temperature tempering of the spring member.

To achieve this and other objects of the present invention, a plate member fastener for joining a first metal plate member to a second metal plate member comprises a barrel, a screw member, a cap and a spring member. The barrel has an inside accommodation space extending through top and bottom sides thereof, a step located on the inside thereof around the inside accommodation space, a top coupling flange extending around the periphery of the top side thereof, a bottom extension tube axially forwardly extended from the bottom side thereof and fitted into a mounting through hole of the first metal plate member. The screw member has a head, a shank perpendicularly extended from the bottom wall of the head for insertion through the mounting through hole of the first metal plate member, a thread spirally extending around the periphery of the shank for threading into a screw hole of the second metal plate member, and a shoulder connected between the head and the shank. The cap is fixedly fastened to the head of the screw member, having a center opening axially extending through the top and bottom sides thereof for receiving the barrel, the screw member and the spring member, bottom coupling means located on the bottom side thereof and coupled to the top coupling flange of the barrel and movable with the cap relative to the barrel between the top coupling flange and the bottom extension tube of the barrel. The spring member is received inside the barrel and stopped between the step of the barrel and the head of the screw member to impart an outward pressure to the cap relative to the barrel.

In one embodiment of the present invention, the barrel has a plurality of notches cut through the top coupling flange; the coupling means of the cap comprises a plurality of coupling blocks that are respectively inserted through the notches of the barrel and coupled to the top coupling flange of the barrel after rotation of the cap relative to the barrel through an angle.

### BRIEF DESCRIPTION OF THE DRAWINGS

FIG. 1 is an elevational view of a plate member fastener in accordance with a first embodiment of the present invention.

FIG. 2 is an exploded view of the plate member fastener in accordance with the first embodiment of the present invention.

FIG. 3 is an exploded view in section of the plate member fastener in accordance with the first embodiment of the present invention.

FIG. 4 is a sectional view of the first embodiment of the present invention, showing the barrel fastened to a first metal member and the spring member sleeved onto the shoulder of the screw member inside the cap before installation in the barrel.

FIG. 5 is a schematic sectional view of the first embodiment of the present invention, showing the plate member fastener installed in the first metal plate member before connection of the first metal plate member to the second metal plate member

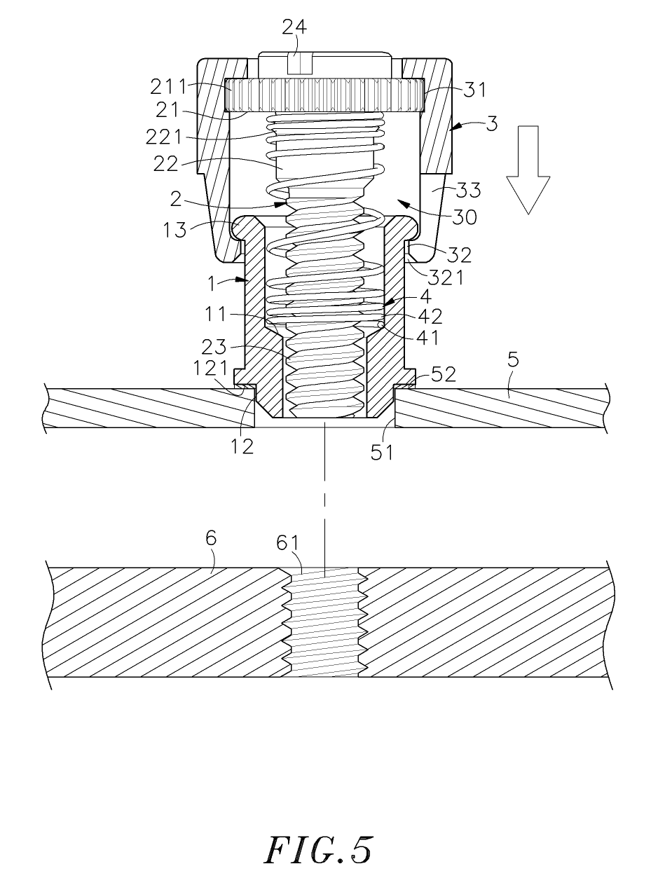

FIG. 6 corresponds to FIG. 5, showing the screw member of the plate member fastener fastened to the screw hole of the second metal plate member at the bottom side of the first metal plate member.

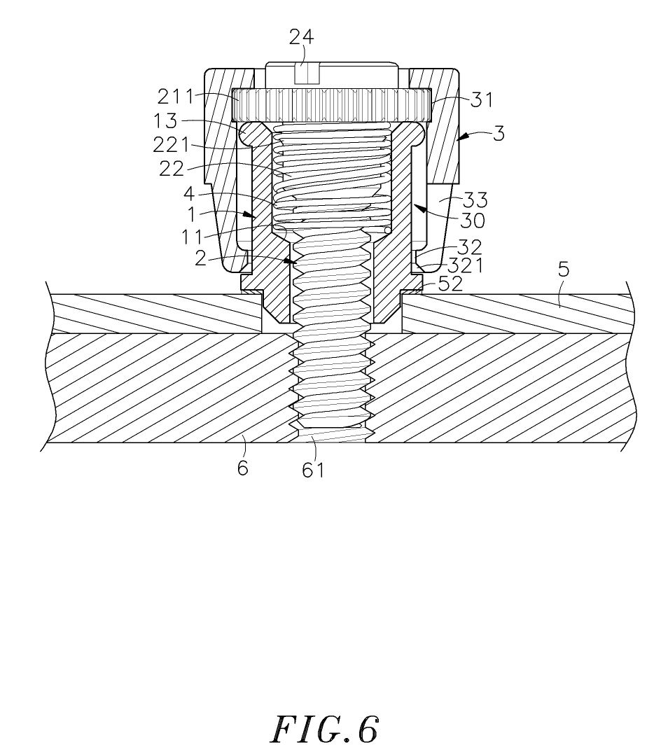

FIG. 7 is an exploded view of a plate member fastener in accordance with a second embodiment of the present invention.

FIG. 8 is a perspective view of the plate member fastener in accordance with the second embodiment of the present invention.

### DETAILED DESCRIPTION OF THE PREFERRED EMBODIMENT

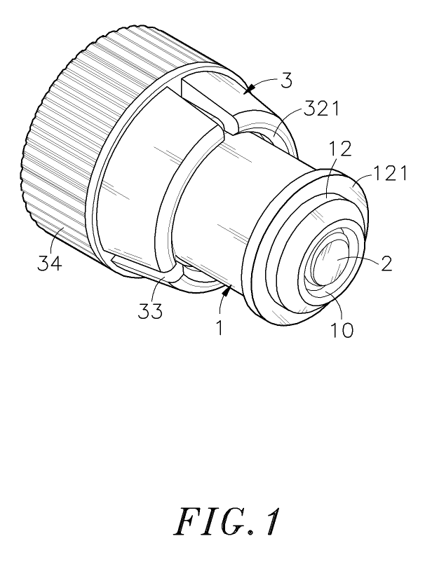

Referring to FIGS. 1˜3, a plate member fastener in accordance with a first embodiment of the present invention is shown comprising a barrel 1, a screw member 2, a cap 3, and a spring member 4.

The barrel 1 is a hollow cylindrical metal member having an inside accommodation space 10 extending through top and bottom sides thereof for accommodating the screw member 2, the cap 3 and the spring member 4, a step 11 located on the inside around the inside accommodation space 10, a top coupling flange 13 extending around the periphery of the top side, a bottom extension tube 12 axially forwardly extended from the bottom side, and a bonding flange 121 extending around the periphery of the bottom side.

The screw member 2 is a metal member having a head 21, an engagement portion 211 formed on the periphery of the head 21, a shank 23 perpendicularly extended from the center of the bottom wall of the head 21, a thread 231 spirally extending around the periphery of the shank 23, a shoulder 22 connected between the bottom wall of the head 21 and the shank 23, a retaining rib 221 extending around the periphery of the shoulder 22, and a tool groove 24 located on the top wall of the head 21. Further, the tool groove 24 can be a Phillipes groove, keystone groove, asterisk groove or hex groove.

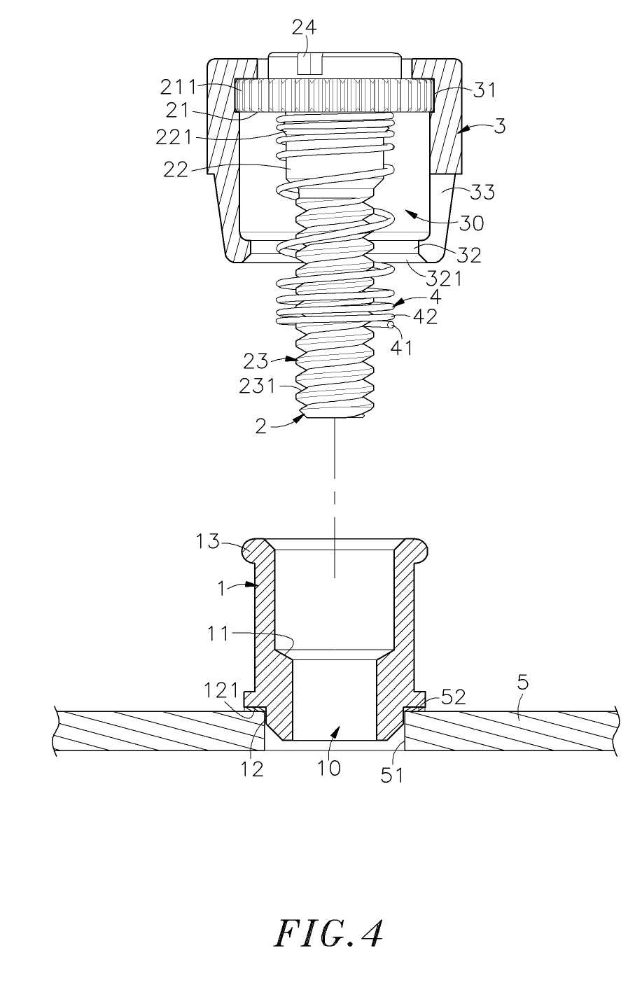

The cap 3 is a hollow member having a center opening 30 axially extending through the top and bottom sides for receiving the barrel 1, the screw member 2 and the spring member 4, an inside retaining groove 31 extending around the inside wall near the top side for retaining the engagement portion 211 of the screw member 2 (see FIG. 4), the bottom coupling flange 32, i.e., a bottom coupling flange extending around the inside wall of the bottom side, a plurality of longitudinal crevices 33 equiangularly spaced around the periphery and respectively extended to the bottom side to separate the bottom coupling flange 32 into multiple parts, and a grip 34 located on the periphery at the top side for gripping by hand. Further, the bottom coupling flange 32 has a beveled guide edge 321 that facilitates insertion of the top coupling flange 13 of the barrel 1 into engagement with the bottom coupling flange 32 of the cap 3.

The spring member 4 is sleeved onto the screw member 2, having a deformable coiled body 42 surrounding the shank 23 of the screw member 2 and two end portions 41 at the two distal ends of the deformable coiled body 42. One end portion 41 is forced into engagement with the retaining rib 221 around the shoulder 22 of the screw member 2 and stopped against the bottom wall of the head 21. The other end portion 41 is supported on the step 11 inside the barrel 1.

The aforesaid screw member 2 is made of metal. The cap 3 is directly molded on the head 21 of the screw member 2 with over-molding technology. After molding, the engagement portion 211 of the head 21 of the screw member 2 that can be formed of a series of barbs, teeth or protruding ribs is formed integral with the retaining groove 31 of the cap 3 so that a user can drive the grip 34 to rotate the screw member 2 into the workpiece.

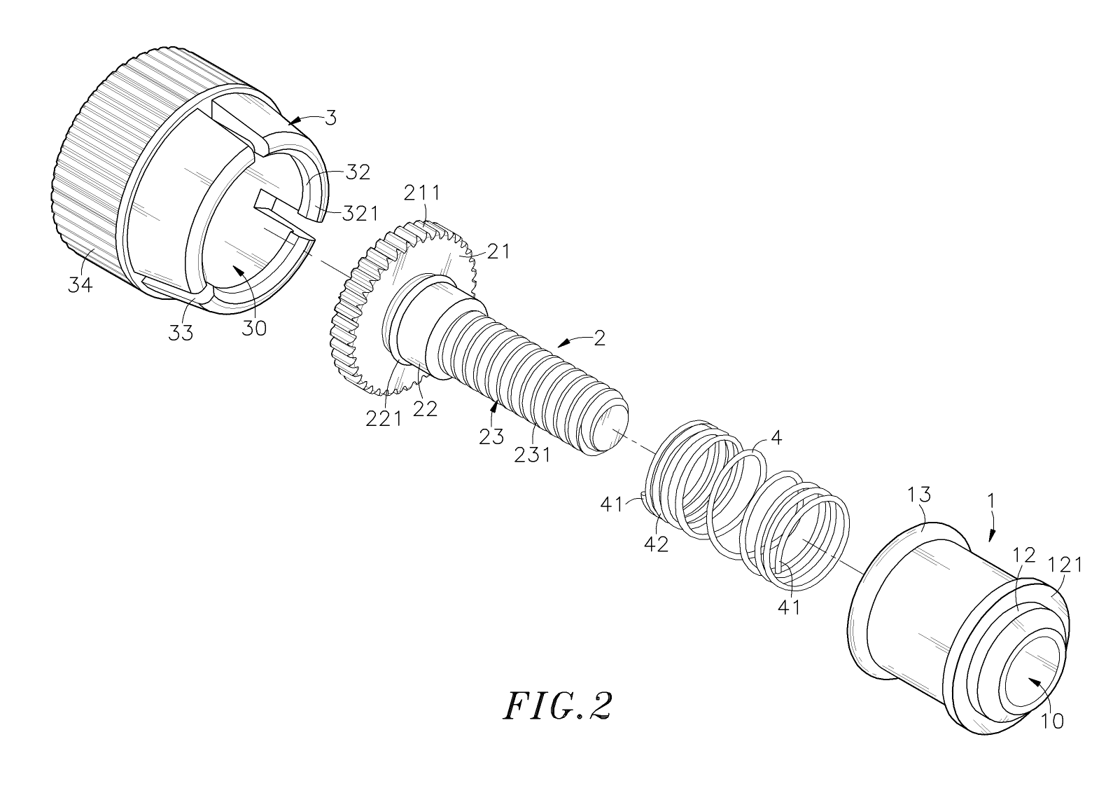

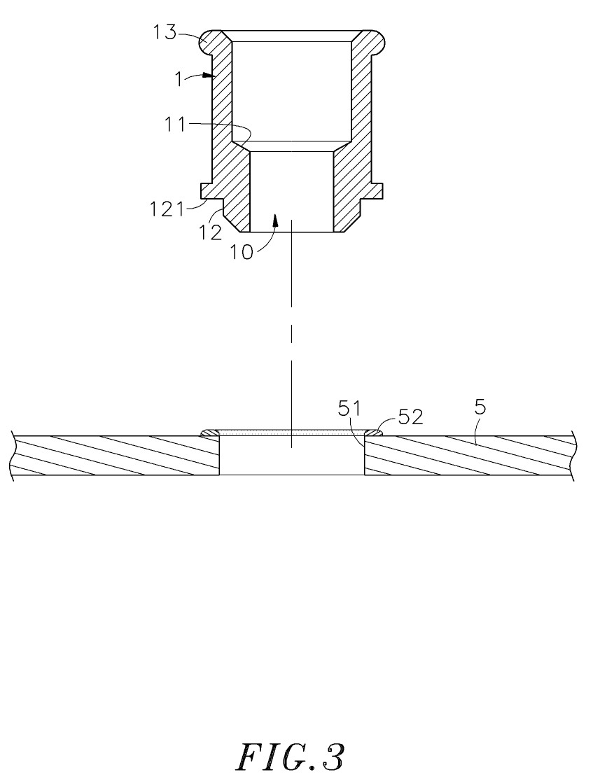

Referring to FIGS. 4˜6 and FIGS. 2 and 3 again, during application, press-fit the bottom extension tube 12 of the barrel 1 into a mounting through hole 51 of a first metal plate member 5. Alternatively, an automatic installation machine can be used to pick up the plate member fastener and then to insert the bottom extension tube 12 of the barrel 1 of the plate member fastener into the mounting through hole 51 of the first metal plate member 5 and to attach the bonding flange 121 of the barrel 1 to a solder paste 52 being applied to the border area of the mounting through hole 51 of the first metal plate member 5, and then a reflow soldering process is applied to have the barrel 1 be bonded to the first metal plate 5.

After installation of the barrel 1 in the first metal plate member 5, sleeve the spring member 4 onto the shank 23 and shoulder 22 of the screw member 2 to force one end portion 41 of the spring member 4 into engagement with the retaining rib 221 of the screw member 2, avoiding tripping of the spring member 4 off the screw member 2 upon a vibration during delivery by an automatic installation machine. Thereafter, insert the shank 23 of the screw member 2 into the inside accommodation space 10 of the barrel 1 to have the two end portions 41 of the spring member 4 be respectively stopped against the step 11 inside the barrel 1 and the bottom wall of the head 21 of the screw member 2, and then force the cap 3 downwards to move the beveled guide edge 321 of the bottom coupling flange 32 of the cap 3 over the top coupling flange 13 of the barrel 1. At this time, the longitudinal crevices 33 enable the split bottom coupling flange 32 to expand and to be moved over the top coupling flange 13 of the barrel 1 smoothly. After the bottom coupling flange 32 of the cap 3 is moved over the top coupling flange 13 of the barrel 1, release the pressure from the cap 3 for enabling the spring member 4 to return to its former shape and to push the screw member 2 and the cap 3 outwards relative to the barrel 1 to the position where the bottom coupling flange 32 of the cap 3 is stopped at the bottom side of the top coupling flange 13 of the barrel 1. Thus, the plate member fastener is assembled, and the screw member 2 is prohibited from escaping from the barrel 1.

When fastening the first metal plate member 5 to a second metal plate member 6, attach the first metal plate member 5 to the second metal plate member 6 to keep the mounting through hole 51 of the first metal plate member 5 in alignment with a screw hole 61 of the second metal plate member 6, and then force the cap 3 downwards and rotate the cap 3 to drive the thread 231 of the screw member 2 into the screw hole 61 of the second metal plate member 6, and then use a hand tool (for example, screwdriver) and attach the hand tool to the tool groove 24 of the screw member 2 and rotate the hand tool to tighten up the connection between the screw member 2 and the second metal plate member 6. Thus, the first metal plate member 5 and the second metal plate member 6 are firmly secured together by the plate member fastener.

Further, when wishing to remove the first metal plate member 5 from the second metal plate member 6, rotate the cap 3 in the reversed direction to disengage the screw member 2 from the screw hole 61 of the second metal plate member 6. At this time, the first metal plate member 5 is unlocked from the second metal plate member 6 and can be directly removed from the second metal plate member 6.

Further, the barrel 1 is fitted with its bottom extension tube 12 into the mounting through hole 51 of the first metal plate member 5 and bonded with its bonding flange 121 to the top wall of the first metal plate member 5 with a solder paste by means of a reflow soldering process before connection of the cap 3 to the barrel 1. This installation procedure prevents color fading or softening of the cap 3 or high temperature tempering of the spring member 4 during reflow bonding of the barrel 1 to the first metal plate member 5, assuring high structural strength for long period application. Further, a number of barrels may be fabricated continuously and linked to one single material strip during production. This fabrication method facilitates product pickup, simplifies the manufacturing process, increases the yield rate and lowers the manufacturing cost. Further, a linked series of barrels can easily and rapidly be installed in one first metal plate member, and the follow-up installation of the respective caps is also easy.

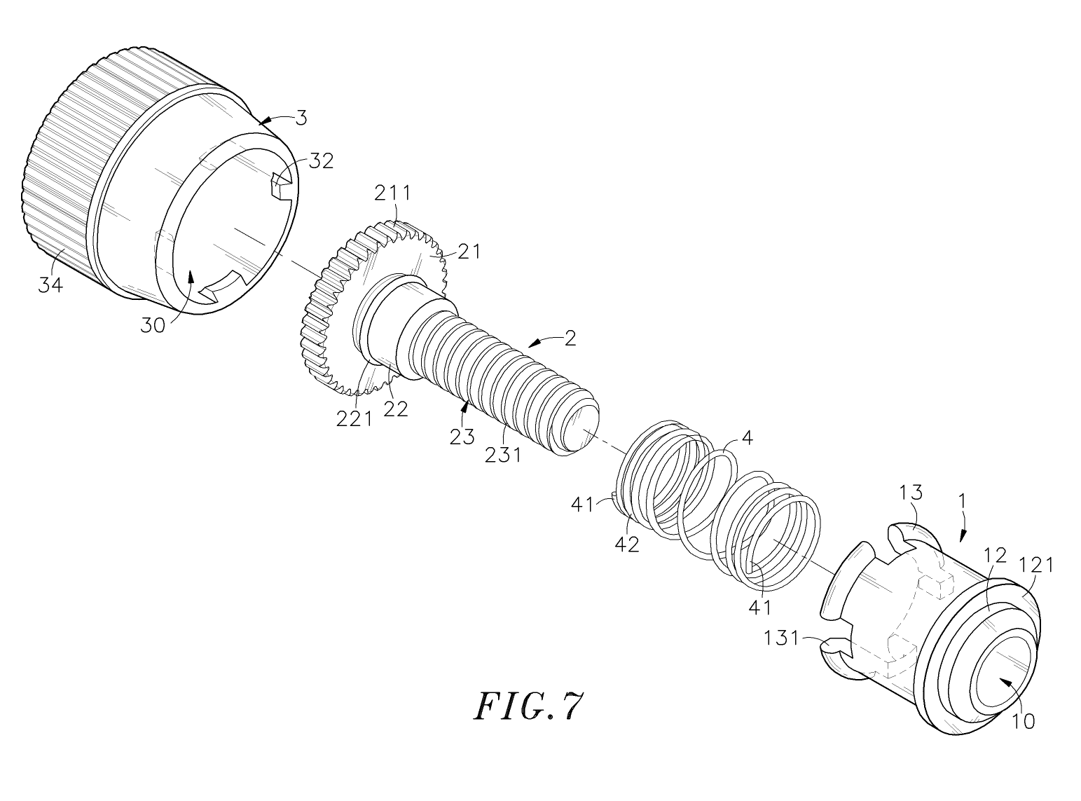

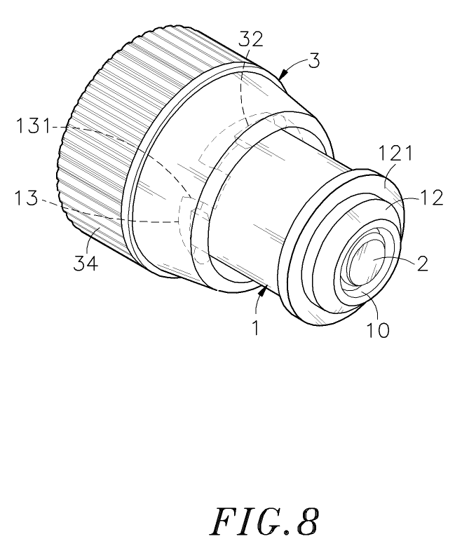

FIGS. 7 and 8 illustrate a plate member fastener in accordance with a second embodiment of the present invention. This second embodiment is substantially similar to the aforesaid first embodiment with the exception of the coupling structure between the barrel 1 and the cap 3. According this second embodiment, the barrel 1 has a plurality of notches 131 cut through the top coupling flange 13 and equiangularly spaced from one another; the coupling means of the cap 3 is formed a number of bottom coupling flange 32 inwardly protruded from the bottom edge of the inside wall of the cap 3 corresponding to the notches 131 of the barrel 1. During installation, aim the bottom coupling flange 32 at the notches 131 and then cap the cap 3 onto the barrel 1 to insert the screw member 2 through the barrel 1 and to force the bottom coupling flange 32 through the notches 131, and then rotate the cap 3 through an angle relative to the barrel 1 to have the bottom coupling flange 32 be stopped at the bottom side of the top coupling flange 13 of the barrel 1. Thus, the screw member 3 can be moved axially forwardly with the cap 3 relative to the barrel 1 to compress the spring member 4. When released the pressure from the cap 3, the spring member 4 immediately pushes the cap 3 backwards to its former position where the bottom coupling flange 32 are stopped at the bottom side of the top coupling flange 13 of the barrel 1 to prohibit escape of the cap 3 from the barrel 1.

A prototype of plate member fastener has been constructed with the features of FIGS. 1˜8. The plate member fastener functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A plate member fastener for fastening to a mounting through hole of a first metal plate member and a screw hole of a second metal plate member to join said first metal plate member and said second metal plate member together, the plate member fastener comprising:
a barrel, said barrel having an inside accommodation space extending through top and bottom sides thereof, a step located on the inside thereof around said inside accommodation space, a top coupling flange extending around the periphery of the top side thereof, a bottom extension tube axially forwardly extended from the bottom side thereof and fitted into the mounting through hole of said first metal plate member;
a screw member, said screw member having a head, a shank perpendicularly extended from a bottom wall of said head for insertion through the mounting through hole of said first metal plate member, a thread spirally extending around the periphery of said shank for threading into the screw hole of said second metal plate member, and a shoulder connected between said head and said shank;
a cap fixedly fastened to the head of said screw member, said cap having a center opening axially extending through top and bottom sides thereof for receiving said barrel, said screw member and said spring member, bottom coupling means located on the bottom side thereof and coupled to the top coupling flange of said barrel and movable with said cap relative to said barrel between the top coupling flange and the bottom extension tube of said barrel; and
a spring member received inside said barrel and stopped between the step of said barrel and the head of said screw member to impart an outward pressure to said cap relative to said barrel.

2. The plate member fastener as claimed in claim 1, wherein said barrel comprises a plurality of notches cut through said top coupling flange; said coupling means of said cap comprises a plurality of bottom coupling flanges that are respectively inserted through the notches of said barrel and coupled to said top coupling flange of said barrel after rotation of said cap relative to said barrel through an angle.

3. The plate member fastener as claimed in claim 2, wherein said notches are equiangularly spaced from one another.

4. The plate member fastener as claimed in claim 1, wherein said barrel has a flat bonding flange extending around the periphery of the bottom side thereof for bonding to a top wall of said first metal plate member with a solder paste after insertion of said shank of said screw member through said mounting through hole on said first metal plate member.

5. The plate member fastener as claimed in claim 1, wherein said screw member has at least one retaining rib protruded from the periphery of said shoulder; said spring member has a deformable coiled body received in the inside accommodation space of said barrel around the shank of said screw member, a first end portion extended from one end of said deformable coiled body stopped at the step of said barrel, and a second end portion extended from an opposite end of said deformable coiled body and forced into engagement with said at least one retaining rib of said screw member.

6. The plate member fastener as claimed in claim 1, wherein said head of said screw member has a tool groove located on a top wall thereof.

7. The plate member fastener as claimed in claim 1, wherein said screw member is a metal screw member; said cap is directly molded from a plastic material on the head of said screw member.

8. The plate member fastener as claimed in claim 1, wherein said coupling means of said cap is a coupling flange extending around an inside wall of the bottom side of said cap; said cap has a plurality of longitudinal crevices spaced around the periphery and extended to the bottom side thereof to separate said bottom coupling flange into multiple parts; said bottom coupling flange of said cap has a beveled guide edge for guiding said bottom coupling flange of said cap over said top coupling flange of said barrel during installation of said barrel in said cap.

9. The plate member fastener as claimed in claim 1, wherein said longitudinal crevices are equiangularly spaced from one another.

10. The plate member fastener as claimed in claim 1, wherein said cap has an inside retaining groove extending around an inside wall thereof; said head of said screw member has an engagement portion extending around the periphery thereof and forced into engagement with the inside retaining groove of said cap.
